(19) United States
(12) Patent Application Publication
(10) Pub. No.: US 2022/0107968 A1
(43) Pub. Date: Apr. 7, 2022

(54) RESOURCE NAVIGATION SYSTEM AND METHODS

(71) Applicant: Washington Metro Area Transit Authority AKA WMATA, Washington, DC (US)

(72) Inventor: Minhua Wang, Annandale, VA (US)

(73) Assignee: Washington Metro Area Transit Authority AKA WMATA, Washington, DC (US)

(21) Appl. No.: 17/496,521

(22) Filed: Oct. 7, 2021

Related U.S. Application Data
(60) Provisional application No. 63/088,754, filed on Oct. 7, 2020.

(51) Int. Cl. G06F 16/29

(52) U.S. Cl. CPC G06F 16/29

(57) ABSTRACT

A system and method for identifying underground attributes on a base-map comprising providing location, positioning, mapping, route planning and geo event management capable of integrating with other platforms. A hybrid visualization tool that combines asset track view, asset data view and asset map view into one single interface to provide users a unified visual display and experience for asset location search, asset data visualization and asset map display.

### CROSS REFERENCE TO RELATED APPLICATION

This application claims priority to U.S. Application Ser. No. 63/088,754 to Minhua Wang filed on Oct. 7, 2020, the contents of which are incorporated by reference in their entirety.

### FIELD OF THE INVENTION

The present invention is generally directed toward a system and method for mapping underground resources.

### BACKGROUND OF THE INVENTION

A large portion of transit system assets are underground. For instance, Washington Metro Area Transit Authority's transit system includes 118 miles of tracks and 91 stations. Of this system, approximately 50% of the rail system is underground, including tunnels, underground stations and underground structures. Underground assets represent rail assets located in these underground facilities, including but not limiting to:
tracks in tunnels,
underground traction power stations,
drainage pumping stations,
tie breaker stations,
emergency trip stations,
communication equipment inside communication room of underground stations, and
switches on the tunnel tracks.

Mapping and location intelligence for underground assets is mission-critical for transit systems to facilitate actionable insights to engineering, maintenance teams, first responders, and safety teams to navigate along the tracks within a multi-level underground station and between underground stations. Locating underground assets is a challenge for transit system maintenance crews, track walkers, engineers, safety inspectors and first responders due to lack of GPS signals, inconsistent or inaccurate location descriptions or references in asset records, and out of date as-built design documents. In the absence of such information and mapping capability, the users have limited or restricted visibility of underground assets. For example, in case of an incident, the first responders and riders do not have visibility on nearest emergency exits. Similarly, the maintenance teams face challenges to determine the location of a traction power sub-station, stepper motors or other equipment or devices that need to be repaired or replaced. With these shortcomings, transit systems may be inefficient, and even incapable in coordinating the priorities and needs of condition assessment and state of good repair to have actionable insights on the location intelligence.

A common way of identifying underground asset location is to map asset locations. However, due to unavailability of GPS signals in the tunnel and inside room of underground station, asset locations cannot be identified using GPS technology. The conventional positioning technologies, such as surveying, 3D laser scanning, and underground penetrating radar scan are also not practical either due to high cost or dynamic change of asset configuration and maintenance. Although as-built design drawings have been widely used in engineering to map asset and structure locations in two-dimension design, such drawing technology is based on design space with no georeferenced coordinates for the design objects.

On the other hand, in the rail industry, a common charting tool, named track chart or straight line diagraming, has been widely used to identify asset locations along track segment based on distance such as mile marker or chain marker. Track chart maps use one dimensional space with straight lines and mile marker or chain marker to label asset location along the tracks. However, due to lack of georeferenced coordinates, such technology is not physically applicable in the field. This poses an inherent challenge for transit systems due to non-availability of economical industry-wide solutions for geo-enablement of underground assets with the existing technologies.

GIS technology has been widely used in transportation, facility management, and asset management to identify facility and asset locations with a pair of coordinates such as latitude and longitude. GIS is a spatial information management system that provides tools to map geo-referenced locations in two-dimensional space. For underground assets, GIS is also facing challenge due to unavailability of geo-enablement of underground asset locations. GIS platforms provide location, positioning, mapping, route planning and geo event management for surface assets. However, there is an industry wide deficit for replicating similar solutions for assets that are below ground. While there are multiple capabilities that help detect items, utilities, pipes and cable below ground using radar technology or satellite imagery technologies, but these solutions tend to provide a superficial image overlay on the surface map with restricted or negligible insights on an intuitive multi-scalar model.

There are solutions that provide pictorial representation of a station either in 2D or 3D view and based on proximity analytical tools, these solutions provide travel pathways based on shortest or nearest route. However, the challenge with these solutions is bringing these routes, positioning and asset attributes on a base-map that can be seamlessly integrated with other platforms. The technology is not matured, and related algorithms are consistently tested and validated by various solutions providers. For example, ESRI has introduced an indoor mapping engine that provides insights of indoor location with outdoor mapping. However, this solution does not address the capabilities to locate, identify, plot and map the assets that are below ground. Given that approximately 90% of assets contain location information in some form, the blind spots for underground assets impede operational efficiencies for the transit system.

In summary, inherent systemic challenges for transit systems exists due to non-availability of industry-wide solutions for geo-enablement of underground assets. Due to inaccurate location positioning on maps, asset owners are forced to be extremely conservative or vague when reporting the location of the underground infrastructure, and it becomes costly and imprecise to manage assets, conduct repairs and maintenance, emergency evacuation etc. Thus, a need exists in the art for a system that accurately and precisely provides location, positioning, mapping, route planning and geo event management for below-ground assets on a base-map that can be seamlessly integrated with other platforms.

### DESCRIPTION OF THE DRAWINGS

FIG. 1 depicts a process of a system to for mapping underground resources, according to various examples;

FIG. 2A depicts a representation of elements in an embodiment of the system.

FIG. 2B depicts a graphical representation of challenges known and an embodiment of a method of the system.

FIG. 3 depicts a graphical representation for an embodiment of a method of the system for locating underground assets.

FIG. 4A depicts a graphic representation of an embodiment of a method of the system to create station indoor basemap layers that are defined by station indoor basemap layer schema and data objects of the system.

FIG. 4B depicts a graphical representation of an embodiment of an in-station location hierarchy of the system.

FIG. 4C depicts an embodiment of an outcome of creating station indoor basemap layers.

FIG. 5 depicts a graphical representation of an embodiment of a method for creating a GIS location identifier.

FIG. 6A depicts a graphical representation of an embodiment of a method of the system to create underground track base layers.

FIG. 6B depicts an embodiment of an outcome of a method of the system for creating underground track base layers.

FIG. 7A depicts a graphical representation of an embodiment of a method of the system for building a track linear referencing network.

FIG. 7B depicts an embodiment of the impact of a method of the system of equation point changing chain marker reference impacting distance measurement.

FIG. 7C depicts an embodiment of a method of the system of locating track and wayside accidents and incidents using track linear referencing network.

FIG. 7D depicts an embodiment of the system of utilizing LRS to locate underground assets along tracks.

FIG. 8 depicts a graphical representation of assets of an embodiment of the system located in underground facilities.

FIG. 9 depicts a graphical representation of an embodiment of a method of the system of locating assets in underground facilities.

FIG. 10A depicts a graphical representation of an embodiment of a method of the system asset location service for non-structured location description.

FIG. 10B depicts a graphical representation of an embodiment of a method of the system of non-structured description pattern analysis.

FIG. 11A depicts an embodiment of a method of the system to create location-based asset content view.

FIG. 11B depicts an embodiment of the method of the system of analyzing location information from structed location views of Asset Management System.

FIG. 12 depicts an embodiment of an asset visualization map of the system.

### SUMMARY OF THE INVENTION

Systems known in the art fail to identify below-ground routes, positioning and asset information on a base-map that can be seamlessly integrated with other platforms. The present system addresses this deficit by providing a system capable of providing location, positioning, mapping, route planning and geo event management for below-ground assets on a base-map and integrating with other platforms.

The method of the present system comprises creating basemap layers as a foundation to locate assets inside underground stations comprising identifying source documents, evaluating source documents and source elements corresponding to station indoor data model objects, creating station indoor basemap geodatabase based on station indoor data model objects, geo-referencing source documents to station indoor basemap with predefined projection, converting source documents elements to station indoor data objects by level and assigning unique GIS location ID, field verification of station indoor basemap layers, and creating station indoor basemap service. In addition, the system can be seamlessly integrated and utilized with other platforms. Therefore, the system and method taught herein is a hybrid visualization tool that combines asset track view, asset data view and asset map view into one single interface to provide users a unified visual experience for asset location search, asset data visualization and asset map display.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown but is to be accorded the widest possible scope consistent with the principles and features disclosed herein.

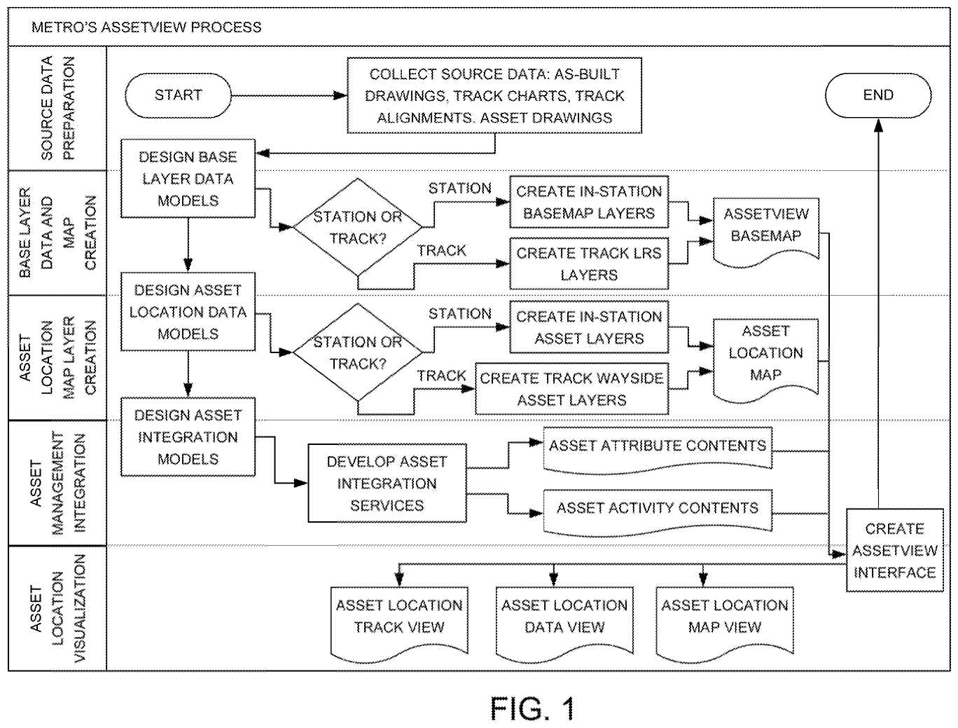

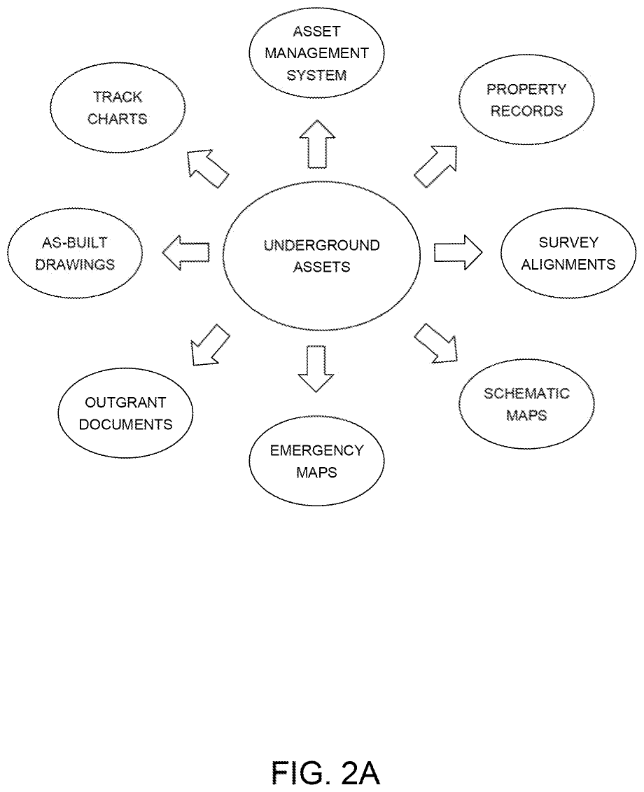

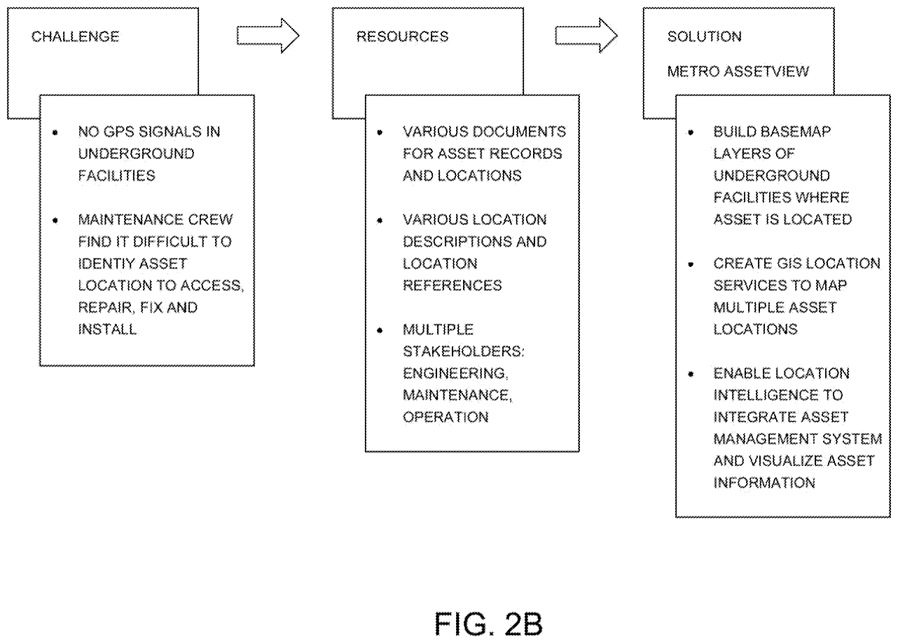

As disclosed herein, the present system is configured to combine geographic information system (GIS) data, track charts, as-built drawings, asset records, and/or proprietary algorithms and provides a unique solution to identify underground asset locations with a single unified visualization map (see FIG. 1). More than 50% of transit system assets are underground. These underground assets include, without limitation, multi-level rail stations, parking garage, station facilities, escalators, elevators, in addition to operational assets between stations. As shown in FIG. 2A, these assets may be initially set forth in various locations. Using the present system, locations of these underground assets, which may be initially set forth in non-geo enabled sources, such as as-built drawings, track charts, and descriptive asset records, become identifiable on two-dimensional geo-referenced maps, hence enabling location-based analytical capabilities for the underground assets.

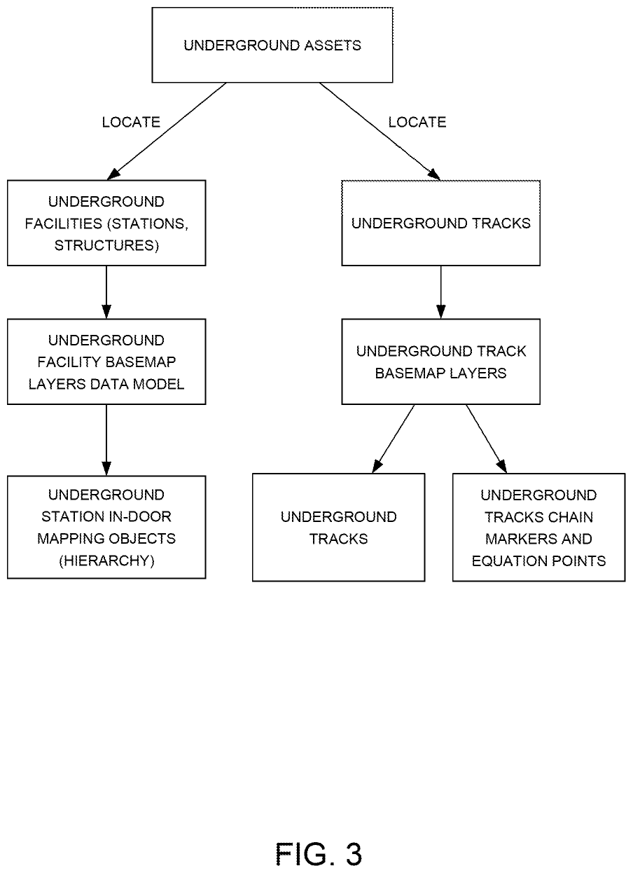

Since underground asset locations are located within underground facilities, whether underground stations or underground track structure (i.e., on track or track wayside), underground facility mapping becomes the basis for identifying asset locations (see FIG. 3). However, as shown in FIG. 2B, there can be challenges associated with translating the asset locations from the initial locations into geo-enabled sources. For assets within underground stations, identifying underground mapping elements (i.e., layers and objects) is essential for underground base-mapping. Most transit system underground stations are complex with multi-level structures, accessed or connected by vertical passageways (e.g., elevators, escalators, and stairs). Thus, mapping underground stations is similar to facility mapping building floor plans, but different in level configuration and more complex due to being located underground.

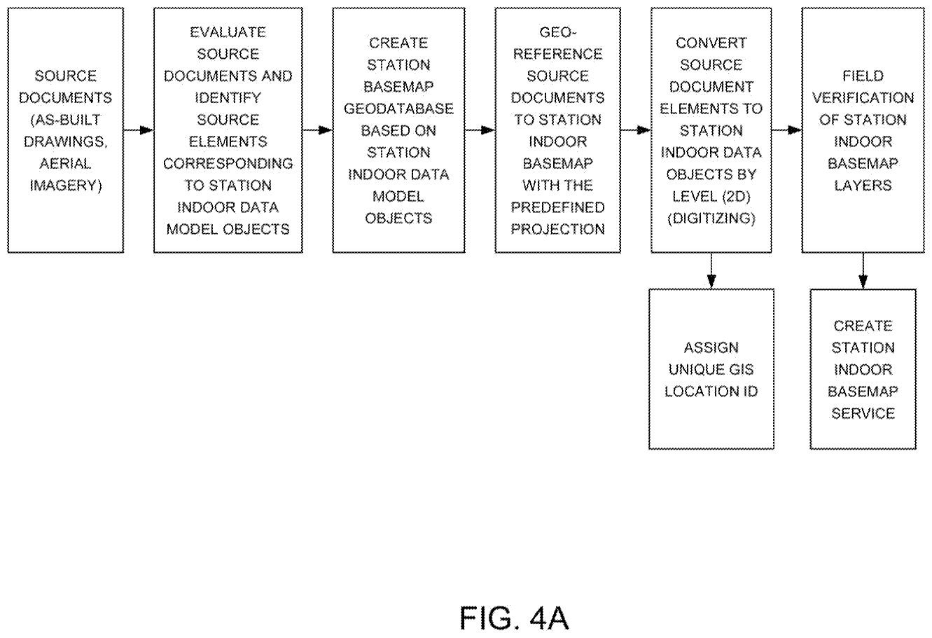

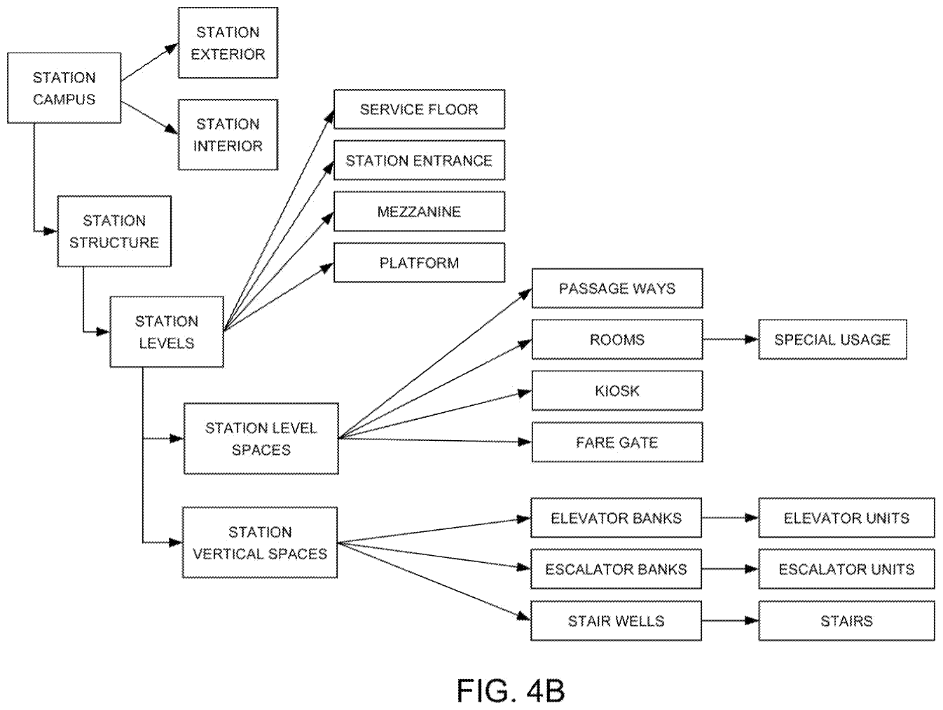

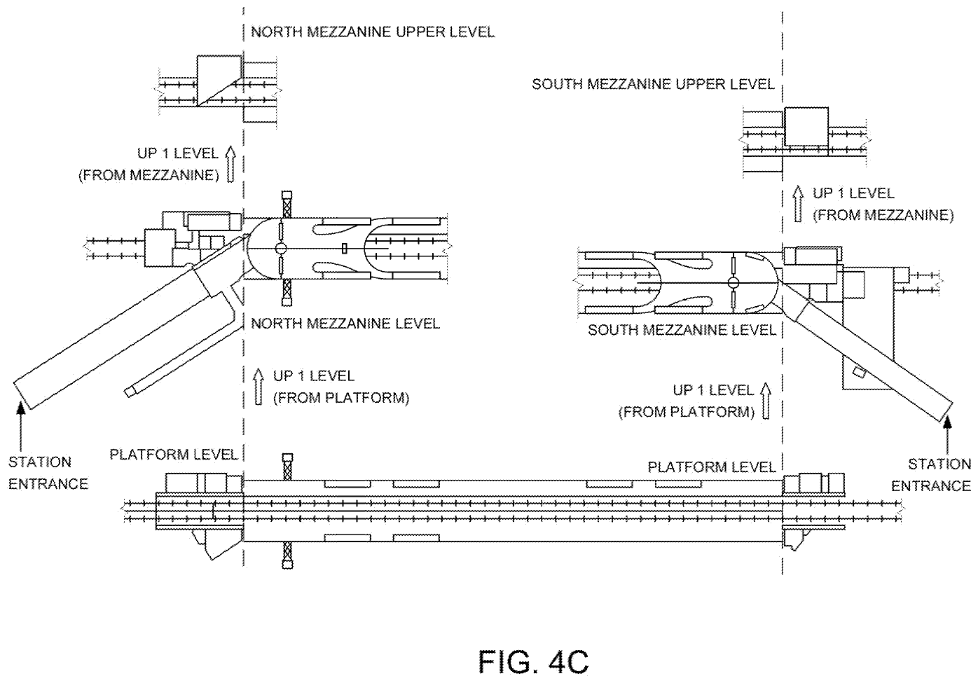

As shown in FIG. 4A, the present system provides a method of creating basemap layer(s) as a foundation to locate underground assets, which may be located inside underground stations and/or along underground tracks. The method may generally include identifying source data documents and evaluating the source data documents and source elements corresponding to station indoor data model objects. Using the information from the source data document, the method may further include creating a station indoor basemap geodatabase based on station indoor data model objects and/or geo-referencing the source data documents to a station indoor basemap with a predefined projection. The method may further include converting the source data documents to elements and/or converting the elements to station indoor data objects by level. In various examples, a unique GIS location ID, or identifying label, may be assigned to each of the station indoor data objects. The method may further include verification of the station indoor basemap layers (e.g., field verification of the station indoor basemap layers). The method may further include creating a station indoor basemap geodatabase service for third party use and access.

As used herein, the term “basemap” refers generally to a collection of GIS data and/or orthorectified imagery that forms the background imagery for a map. The basemap functions to provide background details necessary to orient the location of the map. A GIS map is structured by a combination of basemap layers. Each basemap layer represents a unique type of data, either by the shape, such as point, line or polygon, or by the nature of the data, such as street, building, green land, water body, etc. A basemap layer consists of a number of features with the same type of data. For example, a building is a feature in the building layer.

In the present system, data is collected from various sources to provide descriptive location information and graphics for underground facilities and underground assets. Examples of source data and documentation include, but are not limited to, one or more of the following: as-built drawings for stations, including hard copies of CAD drawings and digital CAD drawings; track charts (one-dimension track schematic charts and chain marker location); track alignments; (digital track alignments with geometry); ATC (Automatic Train Control) charts (one-dimension track schematic charts for automatic train controls, including locations for switches, signals, wee-z Bonds); as-built drawings for yards (hard copies of CAD drawings and digital CAD drawings); asset records (asset location descriptions in Asset Management system and other files (e.g., Excel spreadsheet, PDF, etc.); and as-built drawings for assets. Source data about underground assets may further include schematic maps, emergency maps, Outgrant drawings, property records.

When identifying and evaluating the source data documents, the method of creating an asset location basemap layer may include 1) designing an asset location reference model to handle location reference variances and asset location data objects; 2) converting asset location graphic elements from the source data documents (such as as-built drawings) to GIS location objects; and 3) creating asset location services to take asset location reference input and translate the asset location reference input to mappable location objects (e.g., geo-referenced objects). Each asset location basemap layer may include data for one or more assets or groups of assets. Additionally, each asset location basemap layer may generate locations of the underground assets relative to one or more other map layers, for example, underground track map layers and/or underground station map layers.

The descriptive location information and location graphics from the source data documents are translated to digital geo-referenced location objects and into a format that can be mapped in a GIS. The process that translates descriptive location information and location graphics from source data documents to mappable location objects for basemap layers may involve 1) designing a basemap layer data model and 2) converting location objects from source documents into one or more basemap layers. Building the basemap layer model is similar to building a database model, but each individual table is a map layer and each data record is a location object with geometry.

Designing the basemap layer data model may include designing a station data model and a track data model. The station data model is designed for station location objects and a station spatial data schema, which further comprises defining layers (feature classes), data objects, object types, and data attributes. The track data model comprises a spatial data model for track lines and track wayside data objects. Track line data objects include yard tracks, tunnel tracks, tunnel portals, bridge tracks, tail tracks, pocket tracks, cross-over tracks, connectors, platform lines, revenue lines, chain marker points, and equation points. When designing the basemap layer data model, data objects are identified from one of the source data documents identified above, such as, as-built drawings.

Upon translation of the digital location objects into a GIS mapping format, basemap layers are created for the station and the track. For creation of station base layer maps, CAD objects may be converted to basemap layer features. This may include geo-referencing, and in some examples, this may further include verification (e.g., field-verification) of conversion accuracies. For instance, in various examples, a field crew may be dispatched station by station to verify basemap layer features with a printed map and conduct a visual check in the field. In other words, field verification may be used to confirm the station basemap layers, as noted above. In other examples, verification may occur using digital tools or other confirmation systems (e.g., aerial views, digital maps such as Google maps, or other digital visualization tools).

When creating underground basemap layers, it is critical to understand spatial dependency between mapping elements within horizontal spaces and vertical spaces between levels. The relationship of GIS location objects or mapping elements inside a station, for instance, is not only based on logical structural dependency, such as Station-Mezzanine-Room, but also spatial dependency. For example, a room is inside of a mezzanine floor boundary, and the mezzanine is part of station polygon. For multi-level station spaces or floor plans, the spatial dependency is defined by vertical spaces, such as elevator, escalator, or stairs. The design of a hierarchical structure of the station indoor basemap layer features illustrates such spatial dependency and drives the process of creating the basemap layers and defining the unique location identifier or smart code for location objects in underground stations.

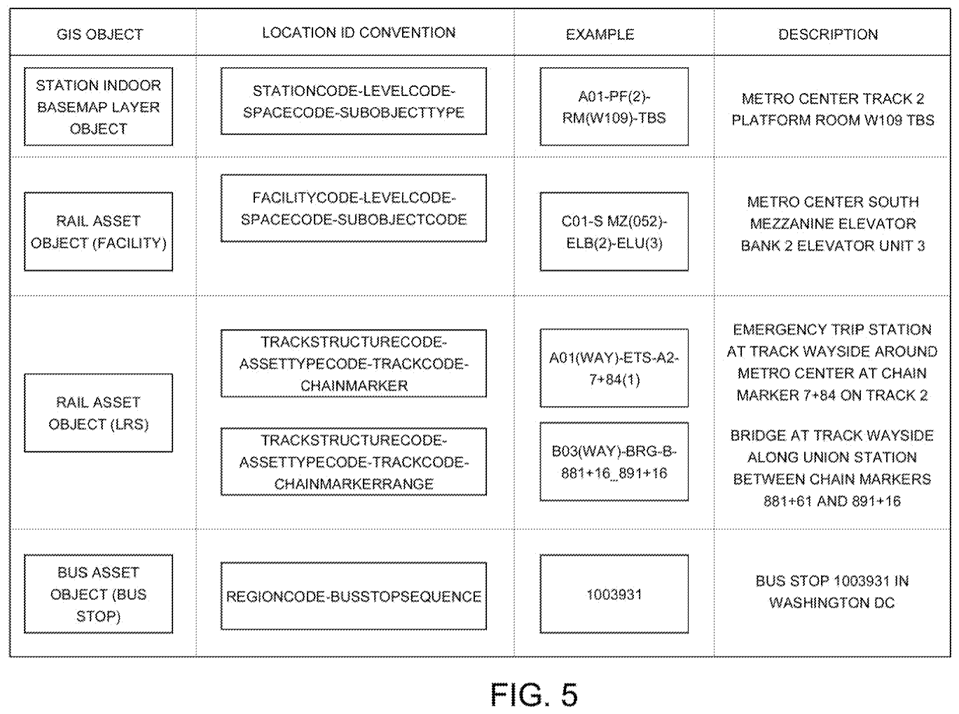

A geo-database schema of basemap layers can be designed based on indoor station location hierarchy and Unified Modeling Language (UML) design methodology. In various examples, in-station location hierarchy is essential for defining station in-door basemap layers and in-station spatial features (location objects) and their relationship, as depicted in FIG. 4B. In-station location hierarchy drives the definitions of in-station location objects and unique GIS location identifier. As shown in FIG. 5, in various examples, labeling of the basemap objects and/or the asset map layer objects may be used. This labeling identifies definitions and the convention used for creating the unique GIS location identifier for transit system assets and facilities. The smart code of GIS location identifier provides standard taxonomy in identifying asset locations.

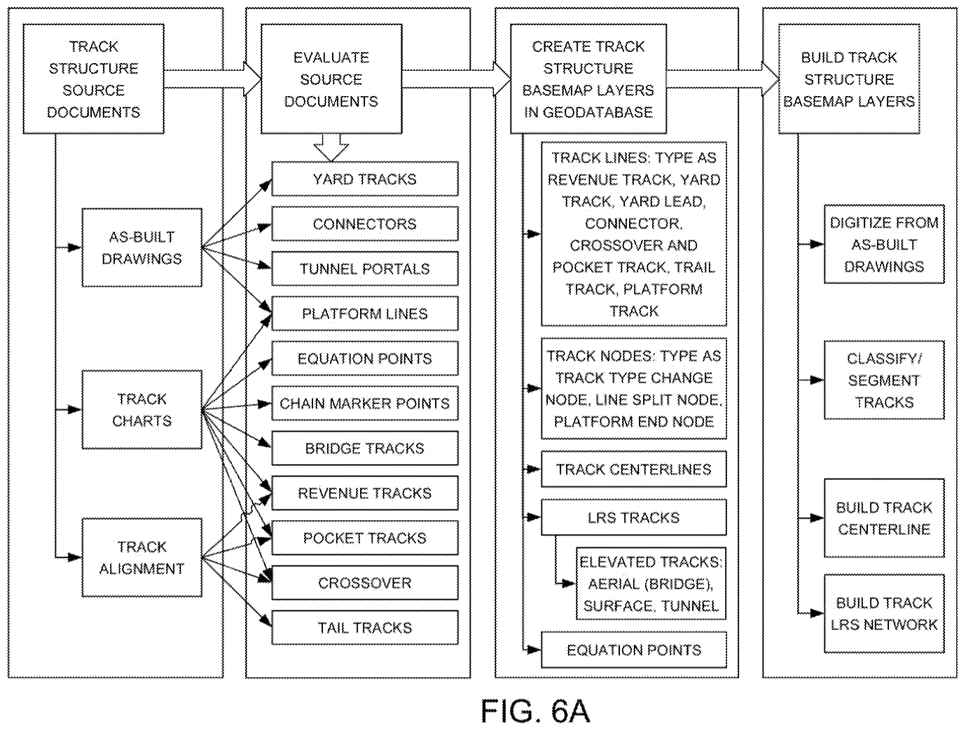

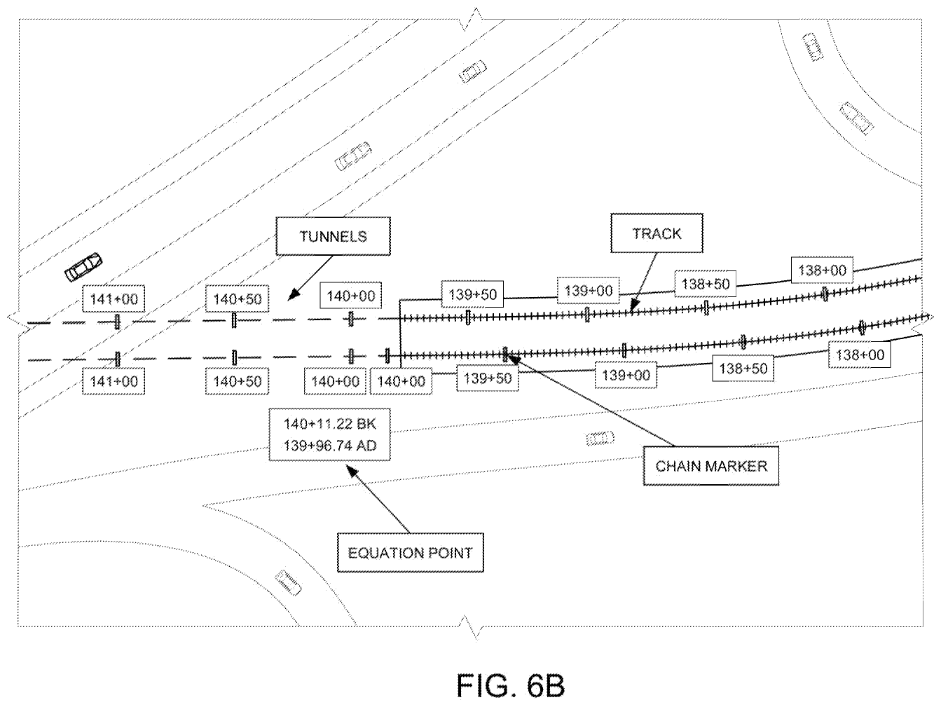

In various examples, underground track basemap layers, which include track lines, track nodes, and track linear reference networks, may be utilized to locate station assets along the tracks and on the wayside. These layers may be pre-existing or may be built using the present system. For example, FIG. 6A shows an embodiment of procedures of the present system to create underground track base layers. The system collects information from track structure source documents, such as as-built drawings, track charts, and/or track alignment records, and evaluates the source documents. The track structure basemap layers are then created using the geodatabase. The track structure basemap layer may be built by any combination of digitizing the as-built drawings, classifying and/or segmenting the tracks, creating a track centerline, and/or building a track linear referencing system (LRS) network. By compiling track elements from multiple sources, a number of underground track basemap layers and track location objects are defined and created in GIS.

The station and track basemap layers allow for asset location basemap layer creation. FIG. 4C exemplifies a potential outcome of creating station indoor basemap layers process and the complexity of multi-level underground station configuration. FIG. 6B shows a potential outcome of creating underground track base layers.

Transit system asset locations are normally described in various ways and stored in multiple formats. Some asset locations are described as graphic elements in as-built drawings, while some are stored in Asset Management System (AMS) or file-based documents. An asset location can be referenced in many ways—a location can be referenced as a place such as a facility or station, or can be referenced as an address, or can be referenced as a distance along a linear segment or can be described by a pair of coordinates such as latitude/longitude. Handling location reference variance when identifying underground asset locations is a challenge in system design.

In most systems known in the art, asset locations are captured in two different types, structured and unstructured. Structured reference type uses database structure (table fields) to store location information, from single column, such as location ID, to multiple columns, such as trackline, start chain marker to end chain marker for linear assets. Unstructured reference type means a location is described as free text, with no standard convention, no word sequence and no limits of words. Alternatively, a location can be referenced as a place such as a facility or station, or can be referenced as an address or as a distance along a linear segment, or can be described by a pair of coordinates such as latitude/longitude. Location reference variance in asset location description input is a significant challenge to the system design in identifying asset locations. Individual location reference models and services designed in this system handle various location description reference inputs and synthesize the inputs to result in the accurate and consistent location geometry. As further described below, an embodiment of the system identifies location description reference types, such as physical address, latitude and longitude or geographic coordinates, and facility name, and then transfers location description to a proper location service to create location geometry for mapping.

One of biggest hurdles in handling location reference variances is how to interpret location description from unstructured location input sources. Most unstructured location descriptions are free-texted words or phrases with location information. Most typical keywords in these free-texted words or phrases may include station code, station name, mezzanine code, facility or asset code (e.g., TPSS code, elevator code, etc.), or from station code to station code (track segment), or track line with start chain marker and end chain marker. These patterns inspire a design of location description pattern repository, which captures common key word patterns in non-structured location description and correspondent location features, codes and names, and services in GIS database. For instance, the location of the asset based on keyword includes a station code, mezzanine code, platform code, and/or facility code. The location description pattern repository serves as a knowledge base for an application to interpret non-structured location description, hence resolving location input variance to a mappable location on a map. The repository can be updated and added to handle any unhandled patterns. In an embodiment of the system, the location description reference type is created via an automated back end service. For example, an artificial intelligence based API can use a pattern to match the input text with the mappable location.

In the present system, individual location reference models and services handle various location description input. Asset location graphic elements are converted from as-built drawings to asset location objects based on asset data models. Unlike locating assets within underground stations, asset locations on tracks or along wayside of tracks are not referenced by base mapping elements or objects; instead, they are referenced by chain marker values of the tracks in a method that is similar to referencing assets along highways using mile marker values on the highway. Track alignments and chain marker points are basic elements of a location referencing system for assets on tracks and along track wayside. Similar to creating station indoor basemap layers, developing a base location referencing system for linear tracks becomes essential for identifying asset locations along linear tracks.

Linear Referencing System (LRS) is a technology widely used in highway and railroad industry. It is defined as a method of spatial referencing in engineering and construction, where the locations of physical entities along a highway (aka linear elements) are described in terms of measurement from a fixed point, such as a mile marker. Similar concepts can be also used in rail tracks, where chain markers are used for referencing. The LRS technology identifies asset locations along highway or rail tracks through a simple straight-line diagram or chart, also known as road chart, or track chart. Distance along linear element becomes a simple location referencing method, rather than a pair of coordinates like latitude and longitude. Similarly, roads and tracks serve as location reference frames for assets along them, just like latitude and longitude serve as location reference on the earth.

While LRS provides a mathematical model to compute asset locations along tracks, building such a model for an entire transit system poses some challenges. One major challenge is the misinterpretation of a reference chain marker with the true distance chain marker point. In the cases of divided tracks, in order to make consistent chain marker values in both directions, true distance from the origin is normally ignored, particularly when one side of track has a bigger curve than the other. Then, the physical chain marker label does not represent the true distance, it is a reference chain marker point.

In the present system, equation points address inconsistent chain markers, wherein the chain markers no longer represent the true distance from the origin of the track. As used herein, an “equation point” describes a reference chain marker point in a curved track segment to set ending chain marker value for the backward segment and reset starting chain marker value for the forward segment in referencing to the identified origin. That is, each equation point has two chain marker values: 1) ending chain marker for backward segment, and 2) starting chain marker for forward segment.

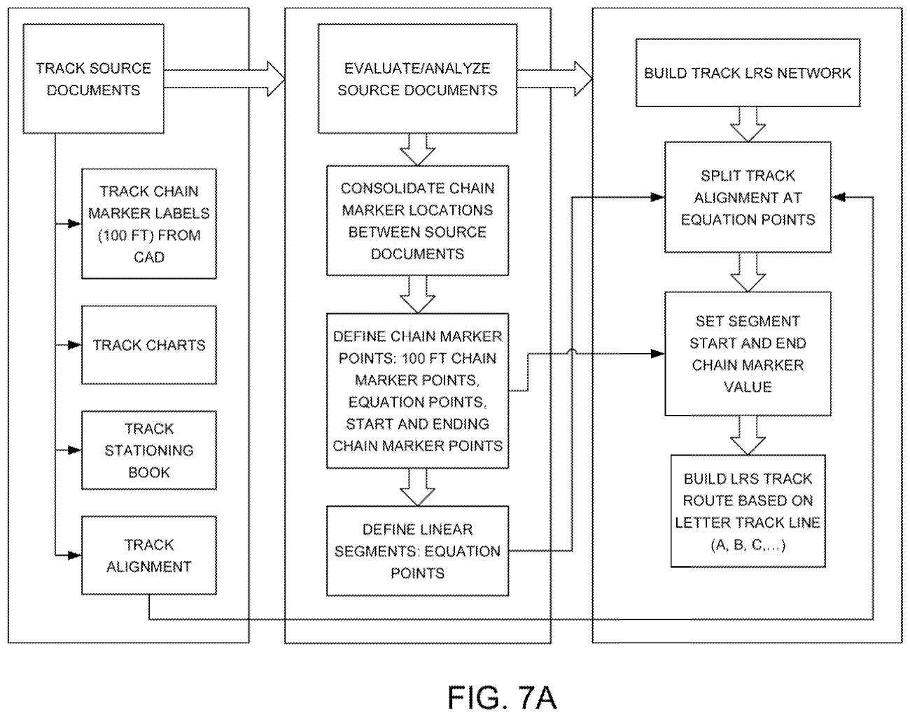

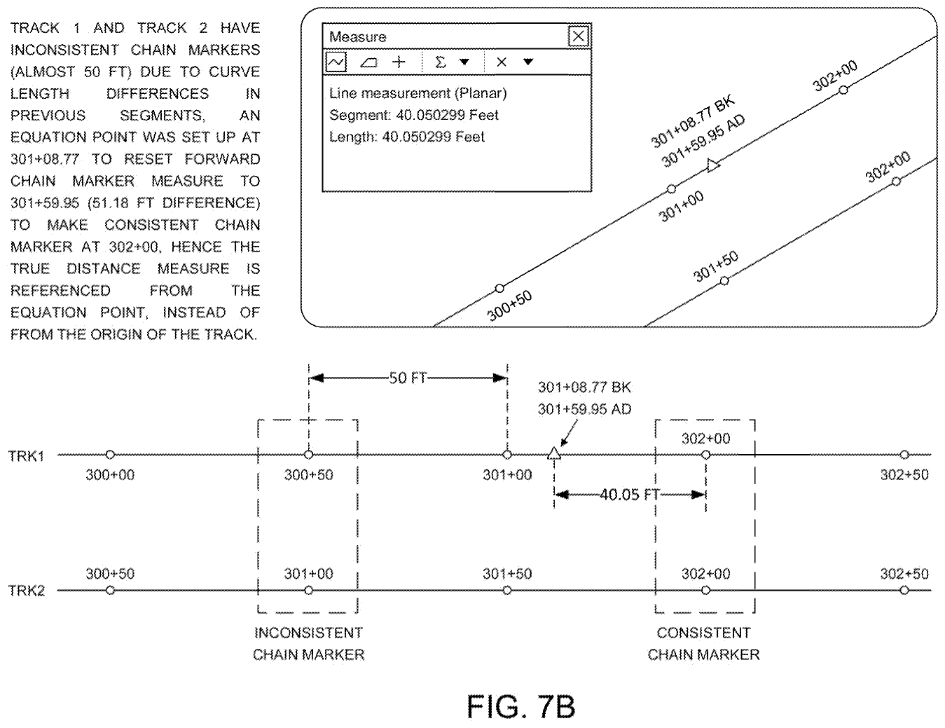

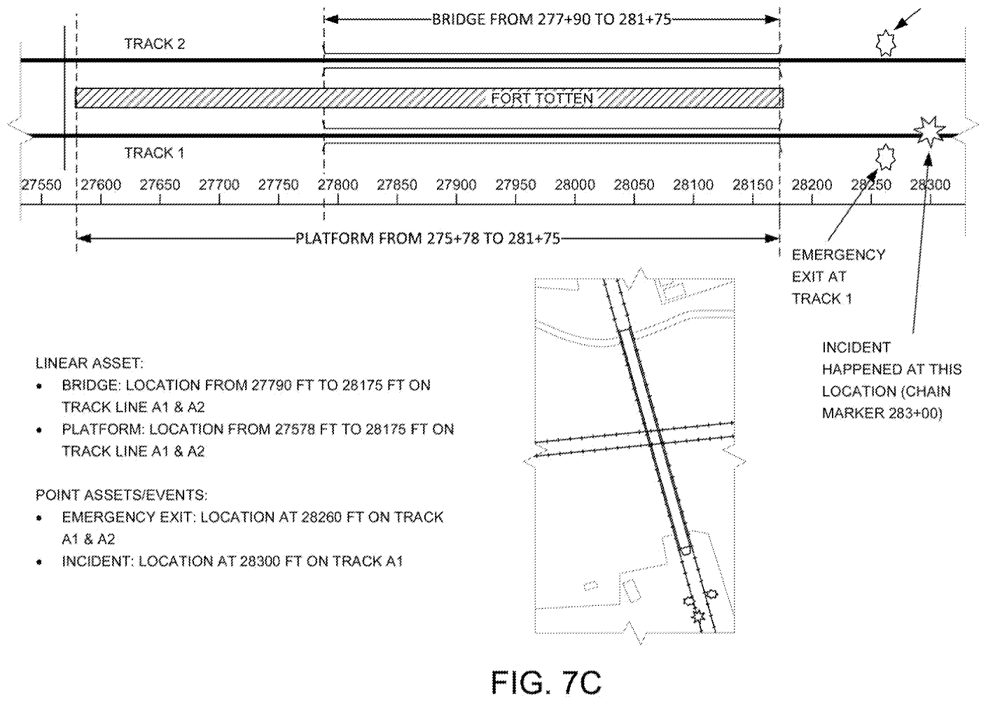

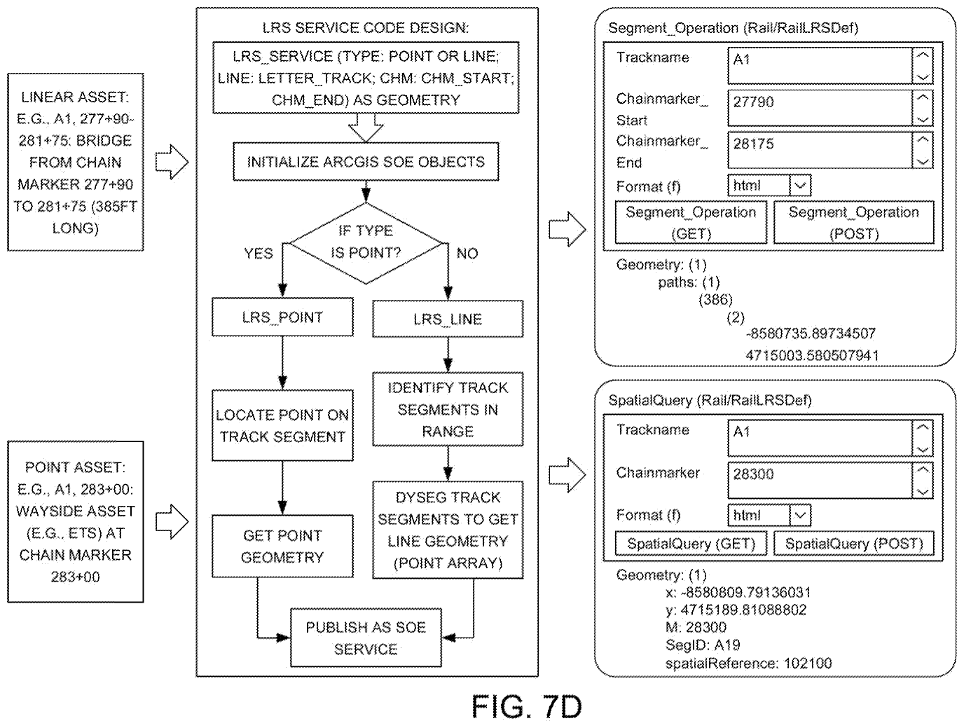

In some track segments, chain marker values at an equation point show significant resetting, as much as 9,141 ft. This is caused by different track segments being constructed at the same time period without knowing the exact distances from the origin of the track, so a random picked chain marker value (a significant number) was set up as reference point and does not reflect a true accumulated distance from the identified origin, as shown FIG. 7B and discussed below. To address the inaccurate chain marker representation and allow for accurate identification and communication of locations underground, such as a track segment, an embodiment of the system utilizes a proprietary algorithm and linear referencing to consider the distance calculation based on equation points and rectify the issue associated with accuracy of distance measures for inconsistent chain markers.

Linear referencing with equation points improves location accuracy when identifying underground asset locations using chain marker values since a physical chain marker label no longer represents the true distance from the identified origin but distance from a chain marker to an equation point represents the accurate distance measurement.

Equation points pose a new challenge in designing track linear referencing system. Instead of creating single linear segment for a track from the origin to the end, a track will be segmented at equation points, all asset locations along a track will be computed based on equation point-segmented LRS. This is the critical element in designing a track location referencing frame, the track linear referencing system for a transit system's underground assets.

Although linear referencing provides an alternative method for identifying asset locations along linear tracks, the derived location is a distance in a linear space, which cannot be directly translated to a location in a geo-referenced map. While GIS maps asset locations with a pair of coordinates such as latitude/longitude, in GIS software, a function referred to as dynamic segmentation is also used to convert linear referencing measures into map locations. Dynamic segmentation is a process of computing the map locations of events stored and managed in an event table using a linear referencing measurement system and displaying them on a map. As a software application programing interface (API), dynamic segmentation can be programed in a custom-built application or service to identify asset location provided with a linear referencing measurement, whether a single distance or distance range. This can be done using a standard tool within a GIS viewing software. Combining linear referencing system methods and GIS dynamic segmentation provides a unique solution to identify underground asset locations along tracks and track wayside. This combination improves the methods disclosed in the prior art and commonly used by transit authorities.

In an embodiment of the system, LRS based asset location model is the asset location reference model for track waysides. FIG. 7A shows a block diagram to build a track linear referencing network, which includes track linear segments with start and end chain marker values, track chain marker points and equation points and track LRS routes (lines) based on transit system letter lines (A, B, C, . . . ) to support locating underground assets along the tracks and on the wayside. FIG. 7B exemplifies how equation point changes chain marker reference and the impact on distance measurement, and FIG. 7C depicts examples of locating track and wayside assets and incidents using a track linear referencing network.

Specifically, in FIG. 7B, Track 1 and Track 2 have inconsistent chain markers (almost 50 feet) due to curve length differences in previous segments. An equation point was set at 301+08.77 to reset forward chain marker measure to 301+59.95 (51.18 ft difference) to make consistent chain marker at 302+00. Thus, in this example the true distance measure is referenced from the equation point, instead of from the origin of the track.

In an embodiment of the invention, LRS service logic locates a transit system's underground assets along tracks using track line and chain marker values. The service is designed as a Server Object Extension (SOE) service with the ArcGIS server API provided by ESRI and combined with an ArcGIS map service, as shown in FIG. 7D.

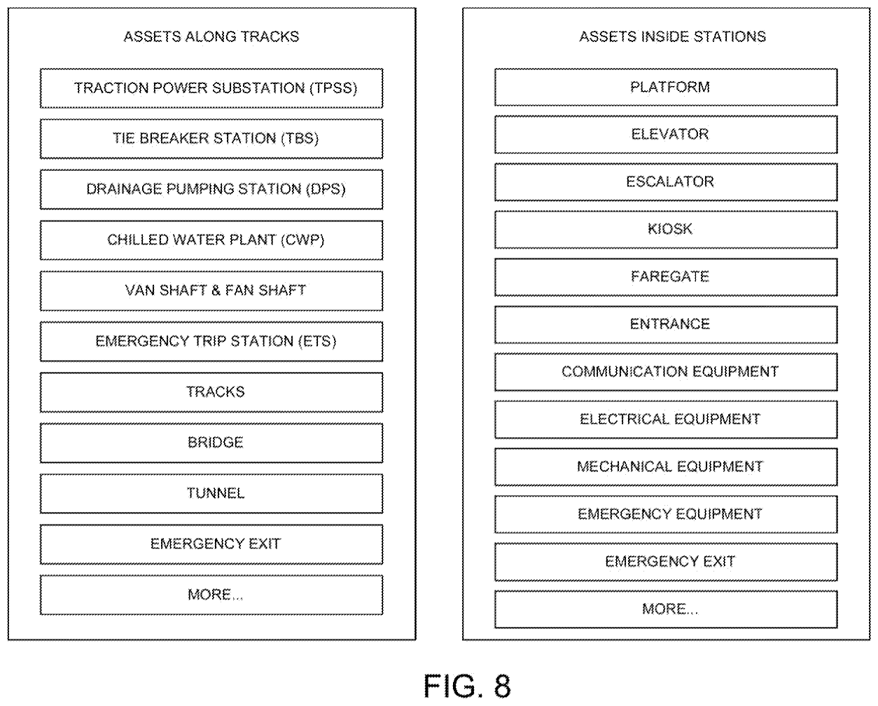

As shown in FIG. 8, assets along the track wayside that may be located include, but are not limited to, Traction Power Substations (TPSS), Tie Breaker Stations (TBS), Drainage Pumping Station (DPS), Chilled Water Plants (CWP), Van Shaft & Fan Shaft, Emergency Trip Station (ETS), track, bridge, tunnel, and emergency exits. All of these items are utilized in the system as source data documents. Various formats for the source data documents of the present system are contemplated herein, including without limitation, hard copies of CAD drawings, digital CAD drawings, and emergency maps (schematic drawings, diagrams in PDF format). FIG. 8 further illustrates assets that may be located within a station such as escalators, entrances, faregates, etc.

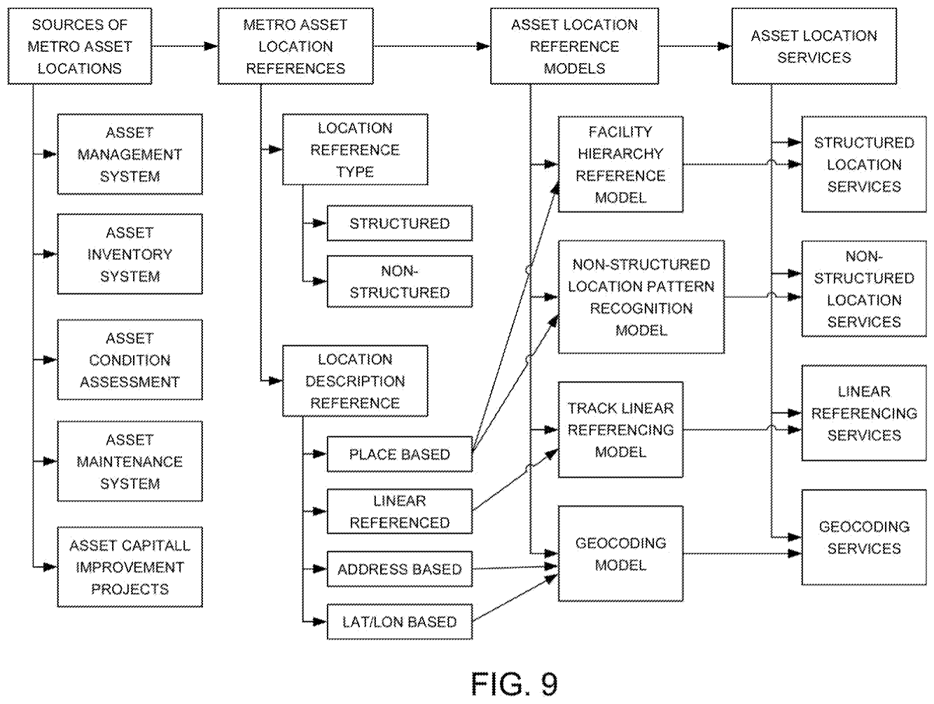

FIG. 9 depicts an embodiment of the system for locating assets in underground facilities and illustrates multiple scenarios and location services used to derive underground asset locations.

In the transit industry, most transit assets and asset activities are stored in an Asset Management System (AMS), such as Maximo, Infor, etc. AMS or enterprise asset management system is used to store and manage asset attributes, asset locations, asset conditions and asset maintenance activities (work orders), and any AMS asset records, including asset attributes, asset conditions and asset maintenance activities, have location references.

In one embodiment of the invention, since most AMS is not a GIS based asset management system, the location definitions in this embodiment are independent from a GIS, causing discrepancies of location definitions for the transit assets between an AMS and a GIS. A core component of the present system is the integration between GIS and AMS based on location. Due to discrepancies of location definitions, the present system developed cross references between AMS and GIS which fall into two categories of location based integration services: 1) structured location references, and 2) unstructured location references. Structured location integration comprise one-to-one or many to many fields' cross references, and unstructured location integration comprise unstructured text field references.

Structured reference type uses database structure (table fields) to store location information, from single column, such as location ID, to multiple columns, such as trackline, start chain marker to end chain marker for linear assets. Extraction of location information from AMS asset attributes and asset activities may contain multiple fields, each of which may find correspondent fields in GIS database. Field mappings between AMS and GIS have been established using a proprietary algorithm to assist applications to match AMS location information, which may include multiple locations with the same definition, to GIS feature classes in order to generate geometries of AMS asset locations and asset activity locations.

In the unstructured reference type, the location is described as free text, without standard convention, word sequence or limits of words. Extraction of location information from unstructured location reference involves matching keywords from free-texted location descriptions to GIS location definitions in GIS database using a proprietary algorithm in order to generate geometries of AMS asset locations and asset activity locations for mapping.

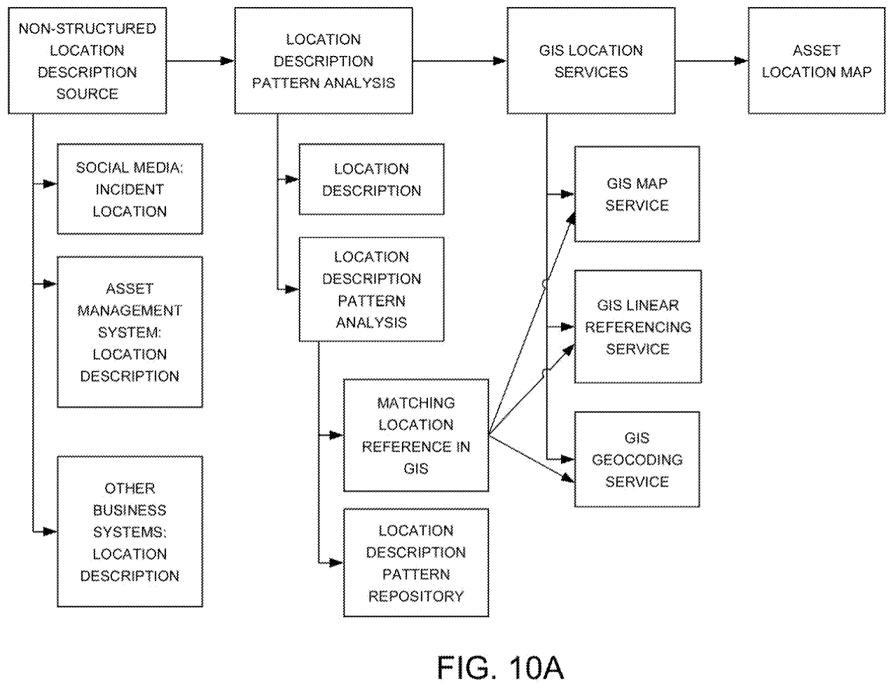

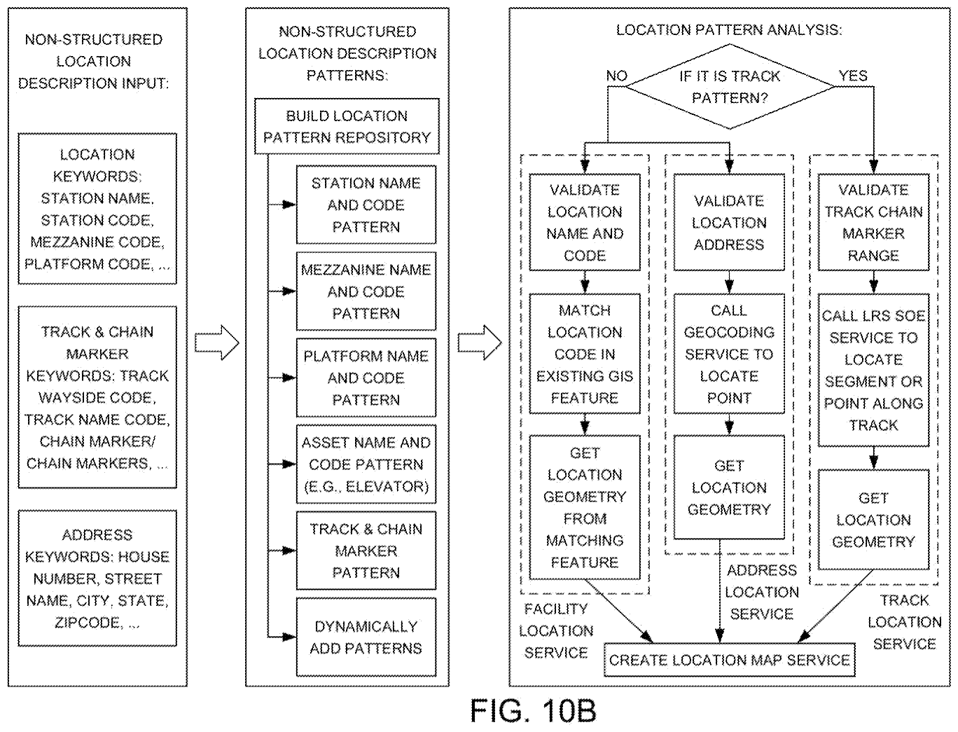

FIG. 10A shows the process to create location-based asset content view by using a proprietary algorithm in which asset attributes, asset conditions and asset work activities are queried from an AMS based on asset location, whether structured or non-structured, through asset location services provided by GIS.

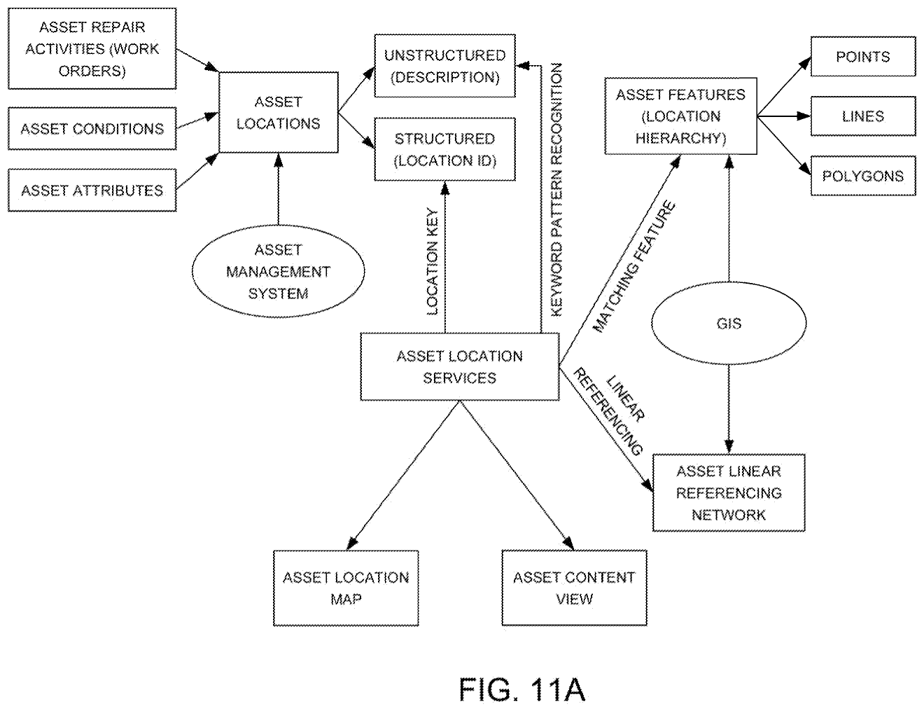

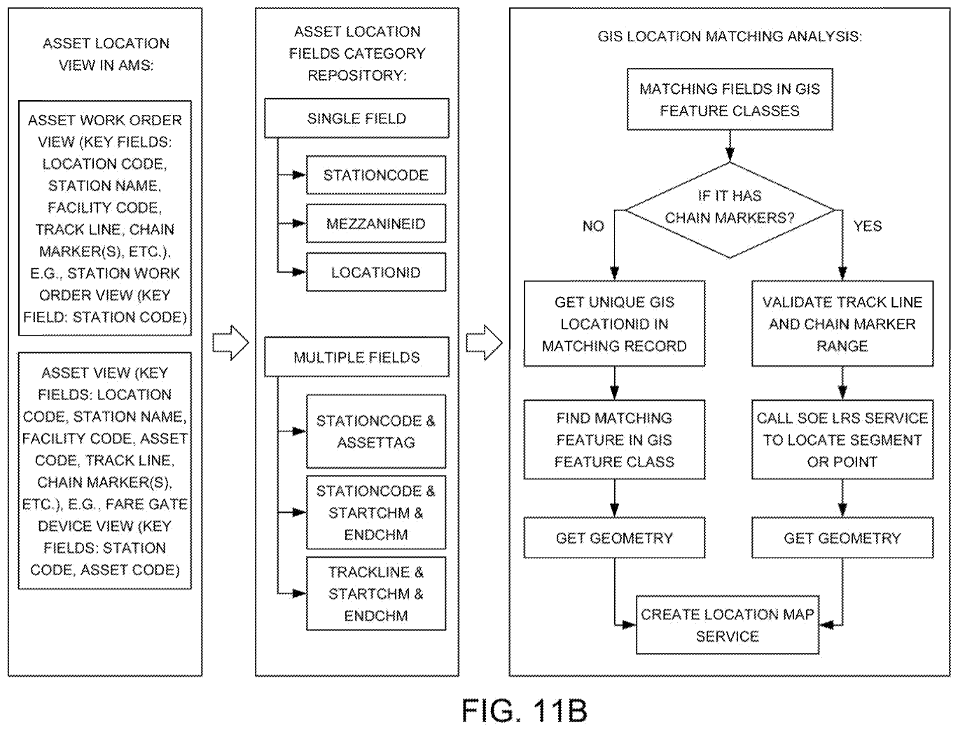

FIG. 10B, shows an embodiment of a process of the system to analyze unstructured location description pattern to match GIS location features and services using a proprietary algorithm and create location geometry on the map. FIG. 11B shows an embodiment of the process of analyzing location information from structured location views of an Asset Management System and matching GIS locations and services to create location geometry on the map.

Thus, the present system is a hybrid visualization tool that combines asset track view, asset data view and asset map view into one single interface to provide users a unified visual experience for asset location search, asset data visualization and asset map display. In an embodiment of the system, Asset Location Track View allows users to view the asset locations in track chart style. FIG. 11A summarizes the process to create location-based asset content view in which asset attributes, asset conditions and asset work activities are queried from an Asset Management System based on asset location, whether structured or non-structured, through asset location services provided by GIS.

Asset Location Data View in an embodiment of the present system allows users to visualize asset attributes, asset conditions, asset maintenance activities and asset documents based on asset locations. This embodiment of the system includes location reference model for address-based facilities. Asset location map services identify location description reference type and then transfer location description to a proper location service to create location geometry.

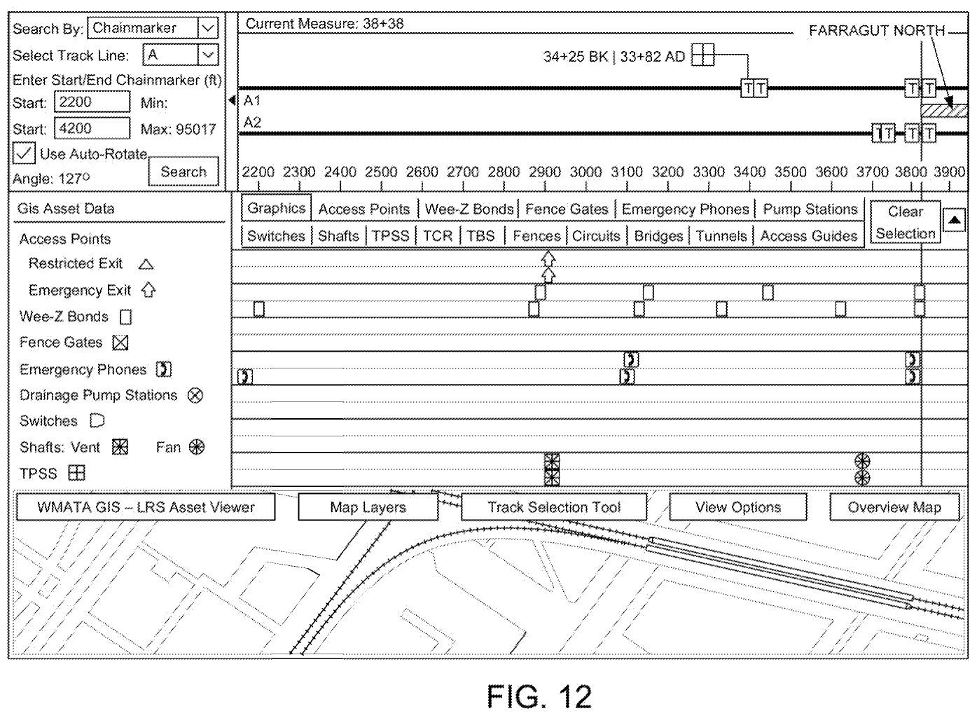

In yet another embodiment, Asset Location Map view allows users to display asset locations on geo-referenced map. FIG. 12 depicts an Asset Visualization Map which combines track chart, asset content view and asset location map in one single visualization interface.

In an embodiment of the invention, the system provides the ability for developers to integrate with basemap service providers such as, Google, ESRI, Apple, etc., to render the newly created web map layer for displaying results on “As a Service” model. This ability of the present system to seamlessly integrate with other systems and platforms is yet another improvement of the systems and methods known in the art and used in the industry. For instance, in an embodiment of the system, the basemap service provider platform is used to create the basemap layer and integrated with the data feed from the present system to map and display the underground asset locations. This integrated service and display can be used by third party systems for various tasks, such as risk and security assessment.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as ‘two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A system for identifying underground asset locations using a single unified visualization display, comprising:
a GIS component;
a basemap layer configured to be viewed using the GIS component;
an underground track base layer configured to be viewed using the GIS component and including reference data for a track and reference data for a plurality of markers positioned along the track;
an equation marker layer configured to be viewed using the GIS component and including reference data for at least one equation point, wherein the equation point is configured to correct inconsistencies in one of the plurality of markers; and
an asset location layer configured to be viewed using the GIS component and including data for one or more assets, wherein the data includes a reference location based on the equation point.

2. The system of claim 1, further comprising:
a station base layer configured to be viewed using the GIS component and including data for one or more stations relative to the track of the underground track base layer.

3. The system of claim 1, further comprising:
an asset management system component including location information; and
a cross-referencing component configured to match the location information to feature classes of the GIS component.

4. A method of identifying underground asset locations using a single unified visualization map comprising:
identifying source data documents;
evaluating the source data documents and source elements corresponding to station indoor data model objects;
creating a station indoor basemap geodatabase based on the station indoor data model objects;
geo-referencing the source data documents to station indoor basemap with a predefined projection;
converting the source data documents to station indoor data objects by level;
verifying the station indoor basemap layers; and
creating a station indoor basemap service for third party use and access.

5. The method of claim 4, further comprising:
designing an asset location reference model to handle location reference variances and asset location data objects.

6. The method of claim 4, wherein geo-referencing the source data documents to station indoor basemap with a predefined projection includes translating descriptive location information and graphics from source data documents to mappable location objects for basemap layers.

7. The method of claim 6, wherein translating descriptive location information and graphics from source data documents to mappable location objects for basemap layers includes designing a base layer data model.

8. The method of claim 6, wherein translating descriptive location information and graphics from source data documents to mappable location objects for basemap layers includes creating one or more base layer maps.

9. The method of claim 7, wherein designing a base layer data model includes designing one of a station data model and a track data model

10. The method of claim 7, wherein designing the base layer data model includes identifying data objects from one or more source data documents

11. The method of claim 8, wherein creating one or more base layer maps includes creating a base layer map for one or more stations.

12. The method of claim 8, wherein creating one or more base layer maps includes creating a base lay map for one or more tracks

13. The method of claim 4, further comprising:
developing a base location referencing system for one or more tracks

14. The method of claim 13, wherein developing a base location referencing system for one or more tracks includes defining one or more chain markers along the one or more tracks and referencing asset locations on or proximate tracks using the one or more chain markers.

15. The method of claim 13, wherein developing a base location referencing system for one or more tracks includes identifying inconsistent chain markers and assigning one or more equation points to correct the inconsistent chain markers.

16. The method of claim 13, wherein developing a base location referencing system for one or more tracks includes segmenting a track at one or more equation points and computing asset locations from one or more of the equation points.

17. The method of claim 13, further comprising:
utilizing the base location referencing system in conjunction with dynamic segmentation to identify underground asset locations.
